(19) United States
(12) Patent Application Publication
(10) Pub. No.: US 2007/0157506 A1
(43) Pub. Date: Jul. 12, 2007

(54) Pest barrier

(75) Inventors: Arie Y Sadovski, Rishon-Lezion (IL); Rueven Shachar, Kfar-Aza (IL); Hana Schwartz, Nahal Shima (IL)

Correspondence Address: BROWDY AND NEIMARK, P.L.L.C.;624 NINTH STREET, NW, SUITE 300, WASHINGTON, DC, 20001-5303, US

(73) Assignee: KAFRIT INDUSTRIES (1993) LTD., Kfar-Aza (IL)

(21) Appl. No.: 10/552,007

(22) PCT Filed: Apr. 5, 2004
(86) PCT No.: PCT/IL04/00313

§ 371 Date: Jan. 23, 2007

(30) Foreign Application Priority Data
Apr. 9, 2003 (IL) 155304

(51) Int. Cl. A01M 1/14

(52) U.S. Cl. 43/114

(57) ABSTRACT

The present invention provides a barrier for protecting against the penetration of pests, wherein a sticky material is incorporated into the barrier. Further provided is a method for protecting against pest penetration, said method comprising of wrapping an article, product or medium to be protected with the protective barrier of the present invention.

### FIELD OF THE INVENTION

The present invention relates to the field of pest protection, particularly to means for protecting against pest penetration and methods of applying said means.

### BACKGROUND OF THE INVENTION

The damages caused by pests to structures, structural elements, communication and electricity cables, foodstuff in various storage locations varying from silos to domestic kitchens are of enormous magnitude which incur immense financial loss. Attempts to achieve pest proofing of materials, articles and the like have been implemented by incorporation of repelling agents and pesticides into said materials. These agents are either toxic or deleterious to the pests. Examples of such practices are found in numerous patents including; WO 0000022, GB 230542, U.S. Pat. No. 4,548,764, U.S. Pat. No. 4,774,082, U.S. Pat. No. 5,290,556, U.S. Pat. No. 5,565,407, U.S. Pat. No. 5,797,353. The active ingredients described in the cited documents as well as in the many other similar disclosures suffer from any of the following limitations; a) they may be toxic thus limiting their handling, processing and manufacturing, b) many of the- active ingredients mentioned are barely stable at processing temperatures used in the compounding stage, in the final product's fabrication, or in both. In some cases they form toxic or unknown degradations products during compounding and/or shaping of the finished product, c) limited tolerance for food packaging application like limited direct contact to food due to toxicity or flavor interactions. Moreover, they all have a limited “shelf life” and an unpredictable and limited efficacy due to depletion of the active ingredient from the said plastic product. It should be noted that this. active chemical is performing it's repellant/attractant/toxicant activity preferably by it's smell or taste, and in order to properly protect the packaged good, the protective layer should withstand, and stay impenetrable under the insects onslaught. Thus, it is imperative that this active chemical will concentrate at the surface of the said protective layer, or close to it. This process of migration towards the plastic product's surface requires, among others, that the chemical will have an ample vapor pressure, thus dictating a finite depletion time for it.

The use of glue to repel or catch insects and/or other animals is also quite common but with a clear distinction that the sticky layer is always exposed at the material surfaces.

The following are examples of disclosers of such applications: EP 0741967, U.S. Pat. No. 6,389,738, EP 1161865.

Accordingly, there is a long felt need for a safe (non-toxic) and conveniently handled material, suitable for protecting foodstuff or other insect susceptible articles, wherein said material is resistant to damages inflicted by pests.

It is therefore an objective of the present invention to provide a barrier which provides protection against insect penetration.

It is yet a further objective of the present invention to provide a method for protecting foodstuff, articles and other media against pest penetration.

Other objectives of the invention shall become apparent as the description proceeds.

### SUMMARY OF THE INVENTION

It has surprisingly been found that pests which attempt to penetrate a protective layer or barrier are deterred when they come in contact with a sticky texture within the layer or barrier.

The present invention provides a barrier for protecting against the penetration of pests, wherein a sticky material is incorporated into the barrier.

According to a further aspect of the invention there is provided a method for protecting against pest penetration, said method comprising of wrapping an article, product or medium to be protected with the protective barrier of the present invention.

### DETAILED DESCRIPTION OF PREFERRED EMBODIMENTS

The following description is illustrative of embodiments of the invention. The following description is not to be construed as limiting, it being understood that the skilled person may carry out many obvious variations to the invention.

Throughout the description the term pests include all animals which the present invention protects against. Non-limiting examples of pests are: insects, rodents, birds and various reptiles. Throughout the specification the term barrier is used to represent a wide array of different types of barriers. In the present context the term barrier may also encompass various packaging, protective wrappings, structures, protective layers, sleeves, bags, sacks pouches, pipes, coatings, paints, films, yarn, fibers, boxes, containers, barrels, jars, canisters, cylinders, flasks, drums, and parting walls. Throughout the specification the term sticky material refers to any substance of sticky, tacky, gluey or gummy texture. More specific non-limiting examples of sticky materials suitable for the purposes of the present invention shall be mentioned.

It has now been unexpectedly found that pests which attempt to penetrate through a barrier are deterred when, in attempting to do so, they encounter a sticky texture. The direct contact between the pest and the sticky material deters the. pest. Thus, incorporating a sticky material within a barrier imparts to the barrier, pest deterrent properties which render the barrier an effective protective barrier against said pests.

The barrier may be constructed from a wide variety of materials. The materials for constructing the barrier are selected according to the intended use of the barrier as may be appreciated by the skilled artisan. Non-limiting examples of said materials include polymers, plastic, paper, rubber, wood, metal and cement. The barrier may be formed as a sheet, film, coating, fabric, sleeve or any structural element. Said forms merely noted as non-limiting examples. Non-limiting examples of polymers which may be suitable materials for constructing the barrier include: polyolefins, e.g., poly alpha-olefin homopolymers and copolymers and blends thereof, preferably wherein the alpha-olefin monomers have from about 2 to about 10 and more preferably from about 2 to about 6 carbon atoms. Non-limiting examples of suitable polyolefins are low density polyethylene (LDPE), linear low density polyethylene (LLDPE), linear medium density polyethylene (LMDPE), linear very-low-density polyethylene (VMDPE), linear ultra-low density polyethylene (UMDPE), high density polyethylene (HPE), polypropylene. (PP),. syniotactic polypropylene (SPP), propylene/ethylene copolymers, propylene/alpha-olefin copolymers or terpolymers polyethylene interpolymers, i.e. copolymers of ethylene with alpha-olefins characterized by a narrow distribution of the molecular weights, the copolymers of ethylene with other monomers, in particular with vinyl acetate, (EVA), wherein the ethylene units are present in an amount greater than those of vinyl acetate, and blends thereof. Polyolefins also include metalocene polyethylene polypropylene; polybutylene polybutene-1 polypentene poly-3-methylbutene-1; poly-4-methylpentene; and polyhexene. Copolymers of olefins and other polymers include such as polyvinyl chloride, polystyrene and polyurethane and mixtures of these. The preferred polyolefines are polyethylene and polypropylene.

For purposes of the present invention a wide variety of sticky materials may be applied wherein any sticky material may be used which does not affect the material of the barrier. The sticky material is made of adhesive components, wherein said adhesive components imparts specially desired performance properties. Said desired properties are adhesion, stickiness, high elasticity and self-sealing. The desired properties of the sticky material are achieved by compounding polymers and other materials that include resins, adhesives, elastomers, and polyolefines. Any suitable adhesive may be employed. Such adhesives include polyurethanes epoxies, polyesters, acrylics anhydride modified polyolefin and blends thereof. The modified polyolefins compositions preferably have at least one functional moiety selected from the group consisting of unsaturated polycarboxylic acids and anhydrides thereof, wherein said unsaturated carboxylic acids and anhydrides are selected from among a group comprising of maleic acid, fumaric acid, crotonic acid, citraconic acid, itaconic acid and the anhydrides of said carboxylic acids. Further examples of adhesive resins suitable for use as the sticky material of the present invention include ionomers (e.g., an ethylene methacrylic acid copolymer cross-linked by metal ions such as Na ions or Zn ions), ethylene vinyl acetate copolymer, ethylene methyl methacrylate copolymer, ethylene ethyl acrylate copolymer, ethylene methyl acrylate copolymer, ethylene acrylic acid copolymer, ethylene ethyl acrylate maleic anhydride copolymer, or ethylene methacrylic acid copolymer. According to a further embodiment of the invention the sticky material may be formed by using an appropriate rubber or elastomer based adhesive comprising one of more kinds of rubber-based polymers such as natural rubber polyisobutylene an A-B-A block, copolymer, or of a Metallocene catalyzed polyolefin plastomers, as the main components and, optionally, a tackifier or a. softener. Non-limiting examples of the more preferred rubber-based sticky materials are a non-curable polyisobutylene-based polymer and an A-B-A block copolymer comprising a polystyrene block, an ethylene-butylene copolymer block, and a polystyrene block. Further, the polyisobutylene-based polymer which is preferably used is a mixture of a high molecular weight type polymer having a viscosity average molecular weight of at least 100,000 and a low molecular weight type polymer having a viscosity average molecular weight of less than 100,000 at a weight ratio of 95:5 to 80:20.

According to a further embodiment, metallocene catalyzed polyolefin plastomers are most preferred as the sticky material The most preferred metallocene catalyzed copolymers are very low density polyethylene (VLDPE) copolymers of ethylene and a C₄ to C₁₀ alpha monolefin, most preferably copolymers and terpolymers of ethylene and butene-1 and hexene-1. The melt index of the metallocene catalyzed ethylene plastomers preferably are in a range of 0.5 g/10 min to 27 g/10 min. The density of the metallocene catalyzed ethylene plastomers preferably are in a range of 0.8500 g/10 min to 0.9100 g/10 min. The preferred range of LDPE blended is 10% to 80% by weight.

The tackifier or softener that may be added to the sticky material can be any appropriate tackifier or softener, preferably having a good compatibility with the rubber-based polymer. Non-limiting examples of the tackifier are aliphatic hydrocarbon resins, and aromatic hydrocarbon resins based on C₉ compounds, C₅ compounds, dicyclopentadiene, coumarone, indene, styrene, substituted styrenes and styrene derivatives. Various alkylphenol resins, terpene and terpene phenolic resins can also be used. Hydrogenated and partly hydrogenated resins are particularly useful tackifiers. Various mixed aliphatic and aromatic resins can be used as well. The adhesive component to be used sticky material preferably contains 1-3, tackifying resins. Non-limiting examples of suitable softeners which may be used in the present invention include a polyisobutylene having a low molecular weight when the rubber-based polymer is a polyisobutylene, and a paraffin oil when the rubber-based polymer is the A-B-A block copolymer. In a metallocene polyolefin plastomer, preferably hydrocarbon resins of aromatic and aliphatic type, more preferably aliphatic type, are employed.

Optionally, the barrier may contain additives such as fillers, pigments, antioxidants, stabilizers and lubricants to impart to the barrier the necessary properties for the intended application. Thermal stabilizers which may be used in the present invention include primary and secondary antioxidants or mixture of thereof. Non limiting examples of thermal stabilizers include commercially available sterically hinderd phenols such as Irganox 1010, 1076, 1330, 3114 and 3125 by Ciba-Geigy, phosphorus-based stabilizer such as Irgafos 160, 12 and 38(by Ciba-Geigy), Mark 329K, PEP36 and PEP-8 (by Asahi Denka Kogyo K.K), sulfur-based stabilizers such as DSTP, DTLP, DLTOIB , DMTP (by Yoshitomi Pharmaceutical K.K.), Seenox 412S (by Shiraishi Calcium K.K), and Cyanox 1212 (by Cyanamide).

The weathering agent optionally blended in the thermoplastic resin composition of the present invention may be any of the conventional compounds which have been used for the purpose of improving the weatherability include UV quenchers such as Ni (II) compounds; sterically hindered amine light stabilizers (HALS) and UV absorbing agents. The UV absorbing agents include 2-hydroxybenzophenones, 2-(2′-hydroxyphenyl)-benzotriazoles, 2-(2′-hydroxyphenyl)-1,3,5-triazines, cinnamates, oxalanilides and salicylates.

The metal deactivators optionally added to the thermoplastic resin of the present invention are not particularly limited, and any conventional compound. which has been used for the purpose of improving the deterioration of the resin by various metals may be used for the metal deactivator. Non-limiting examples include commercially available metal deactivators such as Irganox MD 1024, Chel 180 (by Ciba-Geigy), Naugard XL-1 (by Uniroyal).

The lubricant optionally blended in the thermoplastic resin of the present invention is not particularly limited, and any conventional compound which has been used as the resin lubricant may be used for the lubricant. Exemplary lubricants include. synthetic hydrocarbons such as polyethylene wax; synthetic modified waxes such as montan wax derivative, paraffin wax derivative, and microcrystalline wax derivative; synthetic hydrogenated waxes, metal stearates; synthetic higher fatty acids, fatty acid amides, fatty acid esters and synthetic higher alcohols.

According to a preferred embodiment of the present invention there is provided a barrier constructed of at least two layers. wherein a sticky material is incorporated between the layers. Thus, when a pest penetrates the first layer and encounters the tacky material, it is deterred.

The layers of the barrier may be constructed from the same materials previously described for the barrier. Each layer of the barrier may be constructed of a different material. For example each layer may be of a different type of polymer, or one layer may be of a fabric while another layer may be of paper.

According to a further embodiment of the invention the barrier is constructed of multiple layers, more than two, wherein the sticky material is incorporated between at least two layers, thus imparting improved protection and deterrency of pests.

According to a preferred embodiment the barrier comprises of two layers wherein the sticky material is incorporated between the layers. The layers are composed of polyolefins wherein the thickness of the layer is between 1 to 100 microns, preferably equal or greater than 10 microns.

According to a further embodiment of the invention the sticky material is contained within a capsule and said capsules are dispersed throughout the barrier material. By capsule it is also meant any form which may contain the sticky material, e.g. microcapsules and shelling materials.

According to a preferred embodiment, the barrier is made of a single layer polymeric material, preferably a polyolefin, wherein microcapsules containing sticky material are finely dispersed throughout the single layer. Hence, when a pest attempts to penetrate the barrier, the microcapsules release the sticky material contained therein and deter the pest. The sticky material is generally released when the shell of the microcapsule is penetrated.

According to yet a further embodiment the barrier comprises of two or more layers wherein sticky material is incorporated between the layers and one or more of the layers comprises of capsules containing sticky material.

The barrier of the present invention may be prepared according to techniques known in the art. The techniques for preparing the barrier are process techniques suitable to the material selected for constructing the barrier. Non-limiting examples of said techniques include lamination, extrusion, co-extrusion, extrusion coating, co-injection molding. The preparation of a multi-layer barrier may be carried out by co-extruding the layers while an injector applies the sticky material between the layers during extruding. A further method for preparing a layered barrier comprises of applying a sticky material to one side of a first layer and applying a second layer to said first layer so that the sticky material is sealed between said first and second layer. Said technique also known as lamination. These non-limiting examples of process techniques may be equally applied for the preparation of multi-layered barriers comprising more than two layers.

A non-limiting example of a method of forming capsules of a sticky material within a barrier layer, is the extrusion of a mixture of two incompatible polymers, where one of them forms a continuous phase. in which the other forms a discontinuous phase of microcapsules.

According to a further aspect of the present invention there is provided a method for protecting against the penetration of pests comprising of applying a barrier of the present invention so that it separates between the article, product or medium and the area from where the pest approaches. The barrier may be applied in a wide variety of methods which are selected depending on the article, product or medium to be protected and the type of barrier applied. The type of barrier applied for the purposes of the present method may be selected from any of the barriers hereinbefore described.

According to a specific embodiment of the present method a barrier may be applied as a protective coating for various types of cables. Non-limiting examples of said cables may be communication cables and electricity cables. Said method is particularly useful for protecting underground cables. The barrier may be part of the various protective layers which are known to be used in cable manufacturing processes. According to a further embodiment, the barrier is formed as a sleeve. The cable is then inserted into the sleeve prior to installing the cable. Thus, protecting the cable.

According to a further specific embodiment of the present method, a barrier as herein described is applied as packaging for foodstuff. The term foodstuff as herein applied also includes foodstuff for animals as well as humans, foodstuff at all stages of production; including raw materials for the preparation of foods, grain and other agricultural products and final food products. By packaging it is meant all forms and sizes of packaging, e.g., bags, sacks, boxes, barrels, jars, canisters, cylinders, containers, flasks and drums. One specific method of importance is the use of present barriers for the construction of grain storage structures, also referred to as silos and flexile silos, which are also encompassed within the term package as used herein. The barrier may, in itself be used as a package or it may be incorporated within the package structure, e.g., applying a barrier as one or more layers within the layers constructing a conventional package.

According to a further embodiment of the present method, there is provided a method for protecting structures and structural elements from pests. Said protection may be applied by coating structures or structural elements with a barrier of the present invention. According to a further embodiment, a barrier is applied between the structure and the surroundings thereof. Thus, a barrier may be installed as a fence around a structure, wherein said fence is installed deep in the ground so that pests attempting to approach the structure will encounter the barrier before the structure and be deterred.

According to a further embodiment of the present invention there is provided a method for protecting wood against pests, and particularly termites, comprising of incorporating a sticky material, as hereinbefore described, in the wood. Wherein the wood is processed wood such as plywood the sticky material may be incorporated between the layers of the wood. Hence when termites or other pests attack the wood and attempt to penetrate the layers, they encounter the sticky material and are therefore deterred.

While embodiments of the invention have been described by way of illustration, it will be apparent that the invention may be carried out with many modifications, variations and adaptations, without departing from its spirit or exceeding the scope of the claims.

It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1. A barrier for protecting against the penetration of pests, wherein a sticky material is incorporated in the barrier.

2. A barrier according to claim 1 made of a material selected from among a group comprising of polymers, plastic, paper, rubber, wood, metal and cement.

3. A barrier according to claim 1 or 2 formed as sheets, films, coatings, sleeves, structures, structural elements, packaging, protective wrappings, protective layers, bags, sacks, pouches, pipes, paints, yarn, fibers, boxes, containers, barrels, jars, canisters, cylinders, flasks, drums, silos and parting walls.

4. A barrier according to any of claims 1 to 3 constructed of at least two layers wherein a sticky material is incorporated between the layers.

5. A barrier according to any of claims 1 to 4 wherein the sticky material is selected from among a group comprising of resins, adhesives, elastomers and tackifiers.

6. A barrier according to claim 5 wherein the sticky material also displays self-sealing properties

7. A barrier according to any of claims 1 to 3 wherein the sticky material is contained within a capsule or formed as a capsule and said capsules. are dispersed throughout the barrier material.

8. A barrier according to claim 7 made of a single layer. polymeric material wherein microcapsules containing sticky material are finely dispersed throughout the single layer.

9. A barrier according to claim 8 wherein the polymeric material is selected from among a group comprising of polyolefins, metallocene polyolefins, polyolefin copolymers and terpolymers.

10. A barrier according to any of claims 1 to 9 further containing additives, fillers, pigments, antioxidants, stabilizers and lubricants.

11. A method for protecting against the penetration of pests comprising of applying a barrier of claims 1 to 10 so that it separates between the article, product or medium to be protected and the area from where the pest approaches.

12. A method according to claim 11 wherein said barrier is applied as a protective coating for various types of cables.

13. A method according to claim 11 wherein said barrier is applied as packaging for foodstuff.

14. A method according to claim 11 wherein said barrier is applied for protecting structures and structural elements from pests.

15. A method according to claim 14 wherein said barrier is applied by coating structures or structural elements with a barrier of the present invention.

16. A method according to claim 14 wherein said barrier is applied between the structure and the surroundings thereof.

17. A method according to claim 11 wherein sticky material is incorporated in wood or between layers of plywood.

18. A barrier as herein described.

19. A method as herein described.
